(19) United States
(12) Patent Application Publication
(10) Pub. No.: US 2006/0224778 A1
(43) Pub. Date: Oct. 5, 2006

(54) Linked wizards

(75) Inventors: Mehul Y. Shah, Redmond, WA (US); Vladimir Rovinsky, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/098,631

(22) Filed: Apr. 4, 2005

(51) Int. Cl. G06F 3/00

(52) U.S. Cl. 710/8

(57) ABSTRACT

The subject invention provides a system and/or a method that facilitates invoking execution of computer-implemented instructions. An instruction manager component can execute an instruction as a function of an entity input, wherein a configuration is automatically determined and an advanced configuration is manually determined by the entity input. Additionally, an interface can receive the entity input respective to a user interface. The instruction manager component provides guidance through the execution of instructions, wherein the guidance allows a range of skill-level entities to utilize the instructions accordingly.

### CROSS-REFERENCE TO RELATED APPLICATION(S)

This application is related to U.S. Pat. No. 6,803,925 filed on Sep. 6, 2001 and entitled “ASSEMBLING VERBAL NARRATION FOR DIGITAL DISPLAY IMAGES,” and co-pending U.S. patent application Ser. No. 10/924,382 filed on Aug. 23, 2004 and entitled “PHOTOSTORY FOR SMART PHONES AND BLOGGING (CREATING AND SHARING PHOTO SLIDE SHOWS USING CELLULAR PHONES).” This application is also related to co-pending U.S. Patent application Ser. No. 10/959,385 filed on Oct. 6, 2004 and entitled “CREATION OF IMAGE BASED VIDEO USING STEP-IMAGES,” co-pending U.S. patent application Ser. Nos. 11/074,414, 11/079,151, ______ (Docket No. MS310526.01), and ______ (Docket No. MS310560.01), titled “PHOTOSTORY 3—AUTOMATED MOTION GENERATION,” “PICTURE LINE AUDIO AUGMENTATION,” “PLUG-IN ARCHITECTURE FOR POST-AUTHORING ACTIVITIES,” and ______, filed on Mar. 8, 2005, Mar. 14, 2005, Mar. 28, 2005, and ______, respectively.

### TECHNICAL FIELD

The present invention generally relates to applications, and more particularly, to systems and/or methods that facilitate enhancing a wizard-based user interface.

### BACKGROUND OF THE INVENTION

Continued advancements in computer and networking technologies have transformed the computer from a high-cost, low performance data processing machine to a low cost and efficient communications, problem solving and entertainment system that has revolutionalized the manner in which personal and business related tasks are performed each day. Moreover, the personal computer has evolved from a luxury that was mainly utilized for word processing to a common household item that is utilized to manage finances, control lighting, security and entertainment systems, pay bills, store recipes, search for information, purchase/sell goods, participate in gaming, complete school assignments, etc. The evolution has been facilitated by developments and/or advancements in electrical/electronics related technologies (e.g., chip manufacturing, bus topologies, transmission medium, etc.) and software related technologies (e.g., operating systems, programming languages, networks, etc.).

User Interfaces (UIs) are commonly employed in connection with microprocessor-based devices to enhance a user's ability to view information (e.g., text, options, controls, etc.) and to provide the user with a mechanism to interact (e.g., invoke functionality) with a device wherein the underlying UI code is executing. By way of example, many personal computers today employ operating systems that deploy a UI when booting-up. Depending on system configuration, this UI can provide system configuration information such as power management settings, boot sequence, hardware configuration options, control of a system clock, manual mode selection, etc. In other instances, the UI can provide a framework in which applications can be executed. Commonly, invocation of an application elicits the creation of another application specific UI(s) (e.g., a UI that executes within or over the main UI of the operating system to perform application specific tasks).

For example, a word processor application can be launched from within an operating system UI (e.g., via an icon or menu item), wherein a word processing UI is deployed by the word processing application. The user can utilize this UI to create documents (e.g., via a mouse, a keyboard, and/or via voice recognition features), format text and paragraphs therein, email the document to others, save the document to hard disk, etc. In many instances, even environments that traditionally leverage command line activity utilize a general UI as a framework wherein the UI can be created to provide a user with the ability to easily navigate and access functionality. Most applications provide users with “application workspace” based UI wherein launching the application launches the “main application window” of the application. The user accesses different parts of the application functionality by navigating through menus and toolbar options presented in the “main application window”. In such “application workspace” based application, additional UI windows may be invoked on top of the main application window to perform specific additional tasks—but the center of the application lies in the main application window which displays the current state of the application. Examples of such applications include word processing applications, email client applications and web browser applications.

Alternatively, a user interface for an application can be wizard-based. A wizard based user interface involves invoking a series of windows (or pages) in a sequence to perform a specific task. Each window (or page) can consist of three sections: a header, a body, and a footer. The header portion contains title information informing a user about the step and/or stage of activity that is to be performed. The body can contain the user interface controls for performing a task on the page. The footer can contain controls such as “Next,” “Back,” that allow the user to navigate to the next page or previous page in the sequence respectively. In addition, a wizard-based user interface can include a “Cancel” to close the UI and/or a “Help” to provide assistance relating to the task. Conventionally, wizard-based user interfaces provide strict guidelines and steps without divergence in relation to an application. As a result, the utility of such wizard based applications is limited to applications that require few tasks to be performed - such as configuring network connections or configuring email clients. Wizard-based user interfaces are often easy to understand and easy to follow for novice users because they are guided through the activity. The foregoing describes means to enhance such a wizard-based user interface so that they can be effectively utilized for a wider variety of application scenarios.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

Most software applications require users of the application to complete several tasks or instructions to reach a specific end-result. For example, a word processing application requires the user to type in contents of a document or open an existing document, format the contents of the document by choosing paragraph and text formatting, add headers/footers etc. Similarly, software for creating data CD's requires the user to choose the contents of the CD, select the disk writing drive, select a writing speed, insert CD media into the drive, and write contents to the CD media. Although a specific sequence for these tasks is not always necessary, for novice users, it is useful if the application guides the user to the sequence of tasks or instructions.

The subject invention relates to systems and/or methods that facilitate invoking the execution of computer-implemented instruction(s). An instruction manager component can invoke execution of at least one instruction. For instance, the instruction can relate to, for instance, an application, software, etc. The instruction manager component provides a range of functionality, wherein such range of functionality can be accessed through a user interface (e.g., a wizard, a wizard-based user interface, etc.). In one example, the instruction manager component provides automatic execution of instruction(s) and/or execution of instructions based at least in part upon an entity, wherein the entity can include, a user, a computer, an application or a predefined setting.

The instruction manager component facilitates invoking the execution of instruction(s), wherein the instruction(s) can be related to an application to perform a task. The instruction manager component can utilize a wizard-based user interface to facilitate the execution of at least one instruction. The user interface can guide an entity (e.g., a user) through each step (e.g., stage) towards creating a particular output. Each step and/or stage can be represented by a page in the user interface, wherein each page can instruct the entity on how to perform a specific task towards creating the particular output. The controls for performing each common task at the stage can be available in the page for that stage.

In accordance with one aspect of the subject invention, the instruction manager component can include a save component that provides saving the current state of progress at any point in the execution of instruction(s). The save component allows the entity to save unfinished work regardless of the progress, step, and/or task. Based at least in part upon the duration of possible instructions and respective applications, the save component can also automatically save unfinished work at any stage and/or step within any page during such instructions.

In accordance with yet another aspect of the subject invention, the instruction manager component can include a traverse component. The traverse component allows the entity to traverse throughout the content in the application to perform a specific task or stage. In still another aspect of the subject invention, the instruction manager component can include an access component that can provide direct access to any specific task related to the application and/or instruction(s). The access component allows the entity to randomly utilize any step and/or stage associated with the plurality of tasks related to the application and/or instruction(s). In other aspects of the subject invention, methods are provided that facilitate invoking the execution of computer-implemented instruction(s).

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of an exemplary system that facilitates invoking execution of computer-implemented instruction(s).

FIG. 2 illustrates a block diagram of an exemplary system that facilitates invoking execution of at least one instruction to provide a range of functionality.

FIG. 3 illustrates a block diagram of an exemplary system that facilitates invoking execution of instruction(s) utilizing a user interface that provides versatile functionality.

FIG. 4 illustrates a block diagram of an exemplary system that facilitates manipulation of instruction(s) to provide a range of functionality regardless of user competence.

FIG. 5 illustrates a user interface that provides novice functionality as well as advanced functionality related to images associated to image-based video.

FIG. 6 illustrates a user interface that provides novice functionality as well as advanced functionality related to motion and/or audio associated to image-based video.

FIG. 7 illustrates a user interface that invokes instruction(s) to allow access via multiple clicks to functionality associated with various stages within image-based video authoring.

FIG. 8 illustrates a user interface that invokes instruction(s) to allow access via text links to various stages within image-based video authoring.

FIG. 9 illustrates a user interface that invokes instruction(s) to allow access via image map to various stages within image-based video authoring.

FIG. 10 illustrates a user interface that invokes instruction(s) to allow traversing through content to provide advanced functionality associated to a stage within image-based video authoring.

FIG. 11 illustrates an exemplary methodology for invoking instruction(s) to provide a range of functionality.

FIG. 12 illustrates an exemplary methodology to facilitate invoking a multitude of instruction(s) that provide a range of functionality simultaneously for a novice user as well as an advanced user.

FIG. 13 illustrates an exemplary networking environment, wherein the novel aspects of the subject invention can be employed.

FIG. 14 illustrates an exemplary operating environment that can be employed in accordance with the subject invention.

### DESCRIPTION OF THE INVENTION

As utilized in this application, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

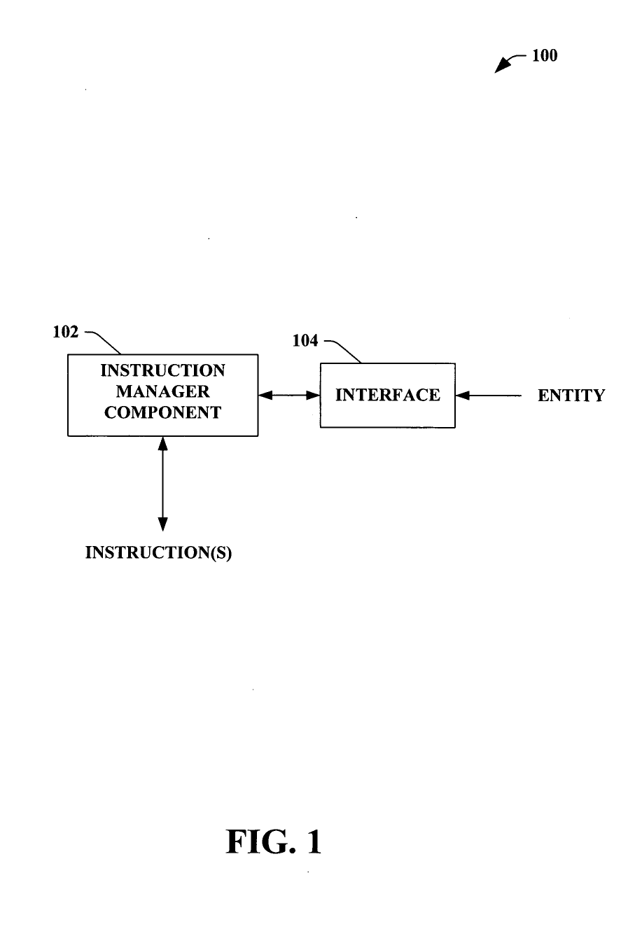

Now turning to the figures, FIG. 1 illustrates a system 100 that facilitates invoking execution of computer-implemented instruction(s). An instruction manager component 102 can invoke execution of at least one instruction. The instruction can relate to, for instance, an application, software, etc. The instruction manager component 102 can provide a range of functionality based at least in part upon the various instruction(s), wherein such range of functionality can be employed in a user interface (e.g., a wizard, a wizard-based user interface, etc.). For instance, the instruction manager component 102 can provide automatic execution of instruction(s) and/or execution of instruction(s) based at least in part upon an entity. It is to be appreciated that the entity can include, but is not limited to, a user, a computer, an application or a pre-defined setting. In other words, by utilizing the instruction manager component 102, the user interface can provide execution of instruction(s) manually or automatically.

For example, consider an application related to creating and/or authoring of image based video. The creation and/or authoring of the image-based video involves various stages such as, but not limited to, incorporating images, arranging images in a sequence, adding motion to the images, inserting audio, etc. The instruction manager component 102 can allow a comprehensive guidance through each stage of the creation and/or authoring of the image-based video. In other words, the instruction manager component 102 can provide a sequential execution of instruction(s), wherein such execution of instruction(s) can be automatic, manual, and/or a combination thereof. In the said example of an application related to creating and/or authoring of image based video, the user is the entity that executes or guides the instruction manager. In one instance, the entity (e.g., a user) can utilize the instruction manager component 102 to automatically apply motion to an image, but allow the entity (e.g., a user) to configure specific options associated therewith. In other words, the instruction manager component 102 can provide the automatic execution of instruction(s) for a novice entities and/or the manual execution of instruction(s) for advanced entities.

It is to be appreciated that the above example is not to be seen as limiting on the subject invention. The instruction manager component 102 can invoke the execution of any suitable computer-implemented instruction(s). For example, the instruction manager component 102 can facilitate the execution of instruction(s) relating to a compact-disc jewel case creator, wherein a user interface can be utilized to provide the execution of such associated instruction(s). In other words, the instruction manager component 102 can provide guidance (e.g., substantially similar to a guide and/or a wizard) for each stage relating to the compact-disc jewel case creation and optionally provide advanced options and/or configurations related to the respective stage. By providing guidance respective to each stage and/or instruction, the instruction manager component 102 facilitates easy implementation for a novice user. By providing advanced options and/or configurations with respect to each stage, it provides the versatility and richness of features that is often desired by advanced users.

The system 100 further includes an interface component 104, which provides various adapters, connectors, channels, communication paths, etc. to integrate the instruction manager component 102 into virtually any operating system(s). In addition, the interface component 104 can provide various adapters, connectors, channels, communication paths, etc. that provide for interaction with the entity and the instruction manager component 102. It is to be appreciated that although the interface component 104 is a separate component from the instruction manager component 102, such implementation is not so limited.

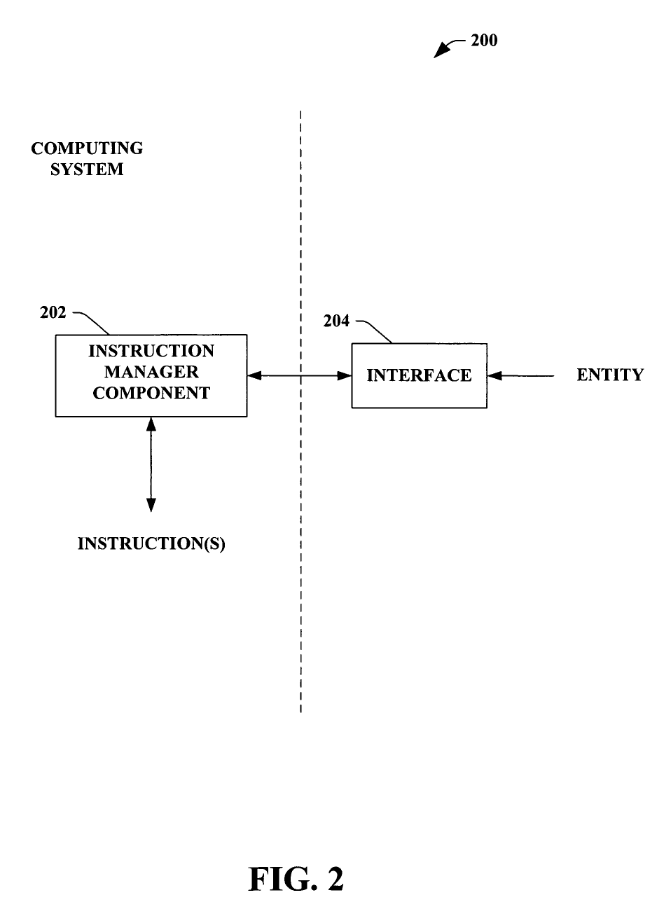

FIG. 2 illustrates a system 200 that facilitates invoking execution of at least one instruction to provide a range of functionality. The range of functionality can be suited to both novice beginner users and professional/advanced users. An instruction manager component 202 can invoke the execution of computer-implemented instruction(s), wherein the instruction(s) can be associated to an entity and the entity can execute the instruction(s). It is to be appreciated that the entity can be a user, an application, a computer, and/or a pre-defined setting. In case the entity is a user, the instruction manager component 202 can employ a user interface that allows the guidance respective to an instruction for producing an output (e.g., wherein producing the output involves at least one stage). The instruction manager component 202 can automatically execute at least one instruction and/or allow the entity to execute the instruction for that stage.

For example, an application can have instruction(s) relating to producing an output, wherein multiple stages can be incorporated. The instruction manager component 202 can guide the entity (user) through the sequence of stages or execution of instruction(s) to produce the output. Yet, the instruction manager component 202 further provides the entity the ability to execute additional advanced instruction(s) in conjunction with each stage or instruction. Similarly, even though the instruction manager component 202 guides the entity through the sequence of stages, it also allows the entity random access to any specific stage as needed by the entity. In another example, the instruction manager component 202 allows a save at any point in the execution of instruction(s) (discussed enfra). Additionally, the instruction manager component 202 provides a preservation of settings associated to the execution of instruction(s). This configuration is to be used in automatic and/or manual configuration of instruction manager component 202 for the next invocation of the application.

The system 200 includes an interface component 204 that can receive an input and/or data relating to the entity. As stated supra, the entity can be, for example, a user, a computer, an application or a pre-defined setting. It is to be appreciated that the interface component 204 can be outside a computing system (as shown), within the computing system, and/or any combination thereof. Moreover, the interface component 204 can be incorporated into the instruction manager component 202, a stand-alone component, and/or any combination thereof to receive the input and/or data related to the entity.

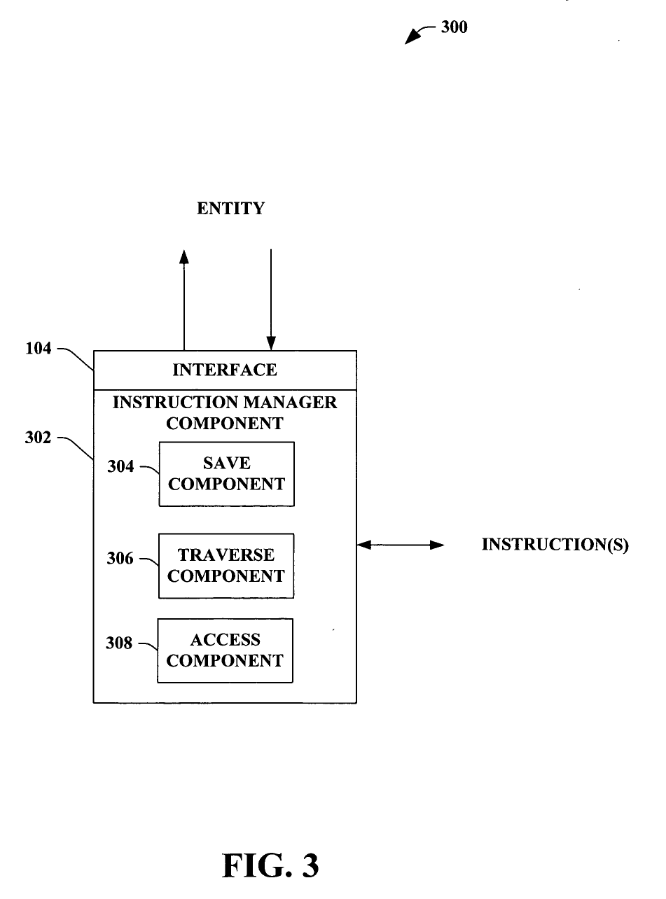

FIG. 3 illustrates a system 300 that facilitates invoking execution of instruction(s) utilizing a user interface that provides versatile functionality. An instruction manager component 302 can invoke execution of instruction(s), wherein the instruction(s) can be related to an application to create an output. The instruction manager component 302 can utilize a wizard-based user interface to facilitate the execution of at least one instruction. The user interface can guide an entity (e.g., a user, an application, a computer, etc.) through each step (e.g., stage) to create the particular output. Each step and/or stage can be represented by a page in the user interface, wherein each page can instruct the entity on how to perform a specific task towards creating the particular output. The controls for performing each common task can be available in the page (e.g., substantially similar to that of a wizard). It is to be appreciated that the user interface utilized is not intimidating to a novice and/or beginner entity based at least in part upon the instruction(s) being on each page and that only common tasks are represented on each page. In addition, a more advanced user can access advanced tasks associated with the stage by invoking, from the page containing common tasks, additional auxiliary windows that provide user interface for the advanced tasks.

Thus, the instruction manager component 302 can provide a comfortable flow of at least one page for various skill-leveled entities (e.g., novice, beginner, intermediate, advanced, etc.) by allowing simplified tasks within pages but also advanced options with tasks by utilizing a set of auxiliary windows. A page can be utilized for each stage in the wizard to include common tasks at that particular stage; however an auxiliary window is invoked optionally from a page to perform advanced tasks related to the particular stage. It is to be appreciated that the instruction manager component 302 can employ the user interface such that advanced settings and/or controls can be invoked. For instance, there could be an “Advanced” button in the main page of the user interface to launch another auxiliary user interface window with the advanced controls associated with the task. Such implementation allows an advanced entity to utilize the advanced features while correspondingly not confusing lower-skilled entities. It is to be appreciated that the user interface employed by the instruction manager component 302 can avoid verbiage that could intimidate a novice and/or beginning entity. For instance, the advanced settings and/or controls can be accessed with a more descriptive and less discriminating reference (e.g., “Customize,” “Options,” “Creative Options,” “Settings,” etc.).

Typically, a user interface provides simplification by employing wizard-based techniques. Yet, the instruction manager component 302 can be employed such that the following can be invoked. The entity can perform common tasks (e.g., stages with related instruction(s)), wherein such tasks are easily discoverable. Most common tasks have default settings. The instruction manager component 302 can instantiate at least one default setting respective to the application to provide a simplification on the number of actions for common tasks. The instruction manager component 302 can automatically perform functions based on at least one of user data. For instance, a default motion can be assigned to one image, while for another image, the entity can manually configure such automated functions. Additionally, the entity can exercise control over what the application does and how it is done. In particular, the instruction manager component 302 can allow the entity to perform more advanced and/or creative tasks. Furthermore, the instruction manager component 302 can be streamlined to address certain common creative scenarios and/or advanced tasks with minimal amount of repetitive work. Typically, the wizard-based user interface constrains the entity by linear, serialized nature of the wizard-based techniques. The instruction manager component 302 can provide a direct access to a majority of instruction(s) on any page (e.g., within any step) of the guidance. Moreover, the instruction manager component 302 can provide a more complicated user interface to execute at least one instruction without intimidating and/or confusing a novice entity, while still guiding the novice entity through the process of completing a task.

The instruction manager component 302 can include a save component 304 that facilitates saving a progress at any point in the execution of instruction(s). The save component 304 allows the entity to save unfinished work and configuration states used and/or selected by the entity regardless of the progress, step, and/or task therein. Based at least in part upon the duration of possible instruction(s) and respective applications, the save component 304 can save unfinished work at any stage and/or step within any page during such instruction(s). For instance, the save component 304 can save the unfinished work automatically at regular intervals (for example, after each stage) or allow the user to manually invoke the save functionality. In case of the latter, in one example, the user interface can invoke a button marked “Save” available at the footer of each page in the wizard to allow the unfinished progress to be saved.

For instance, the instruction manager component 302 can invoke execution of instruction(s) relating to an application that outputs an image-based video and/or a photo story. As stated supra, the image-based video can include adding image(s), editing the image(s), applying motion, adding audio, etc. During any stage and/or step within the guidance of the tasks, the save component 304 provides a save of any work and configuration states regardless of the stage and/or step within the application. In other words, the entity can save image-based video work in the edit image stage regardless of how much of the step and/or if all the steps are complete. If the user decides to terminate the application at any stage, the instruction manager 302 can also prompt the user to save unfinished work.

The instruction manager component 302 can further include a traverse component 306. The traverse component 306 allows the entity to traverse to different parts of the content associated to the application. The traverse component 306 can allow the entity to utilize a task-based flow, wherein a user interface can be employed to perform a task and traverse through different parts of the content to perform the task. The following is an example relating to an image-based video authoring application, wherein the instruction manager component 302 can facilitate executing instruction(s) and is not to be interpreted as a limitation on the subject invention. The entity can select a picture and choose to edit the picture utilizing the advanced options. In this case, from within the advanced option user interface, the user can traverse through all the pictures in the image based video and perform picture editing for any/all pictures. In the absence of such a traverse component 306, selecting a picture in the user interface, accessing an advanced option, editing the picture and closing the advanced option, and selecting another picture to edit can be cumbersome.

In yet another example, the application can be a word processing application, wherein a user interface can be employed to provide various functionalities respective to word processing. For instance, the user can select specific text in the document and invoke the user interface to specify font for the text for a particular section. While the user interface to specify font is invoked, the traverse component 306 can allow the user to traverse through different parts of the document (including header/footer) and adjust the font throughout the entire document.

The traverse component 306 can allow the entity to traverse through all of the content associated to the application, wherein the content can be manipulated by the application. For instance, as discussed above, the content can be pictures in relation to the image-based video application. In one example, the entity can be in an advanced setting, wherein the entity can select to move to the next picture or the previous picture. The entity can open an advance setting for a task and by utilizing the traverse component, perform the task for a set of pictures. In other words, the traverse component 306 facilitates executing instruction(s) relating to a specific advanced task throughout the entire content associated with the application.

The instruction manager component 302 can include an access component 308 that can provide access to at least one task related to the application and/or instruction(s). The access component 308 allows the entity to randomly utilize any step and/or stage associated with the plurality of tasks related to the application and/or instruction(s). By utilizing the access component 308, the entity need not navigate serially through the user interface to complete and/or edit a specific task; rather, the entity can “jump” “backward” or “forward” to a particular task page and/or stage.

In one example, the advanced operation(s) and/or tasks that are available through auxiliary windows in previous pages and/or stages can also be available through an advanced option in the current page. In other words, when the entity is on the page and/or stage for a particular task, the access component 308 can provide a context menu that allows the entity to access various advanced operations and/or tasks associated to the application. Following the image-based video application example, the entity can be on the audio page, yet access the editing of the picture by utilizing the context menu. In yet another example, the access component 308 can provide a “one click access” to any page and/or step associated with the application and/or instruction set. The entity can click on an option within the user interface to allow the entity to “jump” to any page and/or step in the application and/or instruction(s). In still another example, the access component 308 can provide a visual map of the pages and/or stages to indicate where in the application and/or instruction(s) the entity is located in relation to completion of the output and to facilitate “one click” jump to any other page and/or stage of the application.

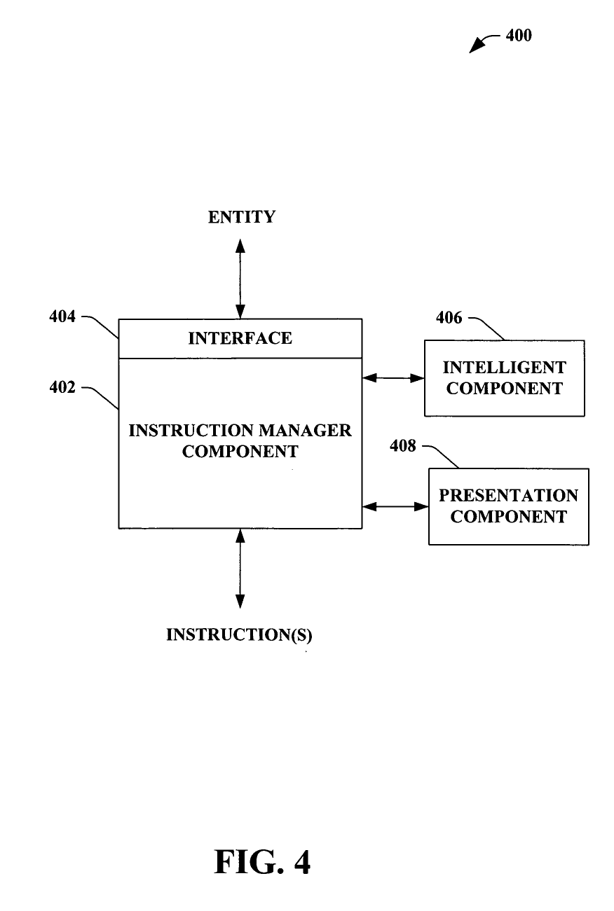

FIG. 4 illustrates a system 400 that employs intelligence to facilitate manipulation of instruction(s) to provide a range of functionality regardless of user competence. The system 400 can include an instruction manager component 402 and an interface 404 that can all be substantially similar to respective components described in previous figures. The system 400 further includes an intelligent component 406. The intelligent component 406 can be utilized by the instruction manager component 402 to facilitate executing instruction(s) related to an application by employing a user interface based at least in part upon a wizard. For example, the intelligent component 406 can be utilized to facilitate determining an entity trend and/or preferences in relation to the instruction(s) and various operations, tasks, stages, and/or steps. In particular, the intelligent component 406 can employ a user profile and/or historic data to determine such user preferences and/or settings relating to a particular instruction(s) and/or application.

It is to be understood that the intelligent component 406 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

A presentation component 408 can provide various types of user interfaces to facilitate interaction between an entity (e.g., a user, a developer, an application, a computer, etc.) and any component coupled to the instruction manager component 402. As depicted, the presentation component 408 is a separate entity that can be utilized with the instruction manage component 402. However, it is to be appreciated that the presentation component 408 and/or similar view components can be incorporated into the instruction manager component 402 and/or a stand-alone unit. The presentation component 408 can provide one or more graphical user interfaces (GUIs), command line interfaces, and the like. For example, a GUI can be rendered that provides a user with a region or means to load, import, read, etc. data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such vertical and/or horizontal scroll bars for navigation and toolbar buttons to determine whether a region will be viewable can be employed. For example, the user can interact with one or more of the components coupled to the instruction manager component 402.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the invention is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

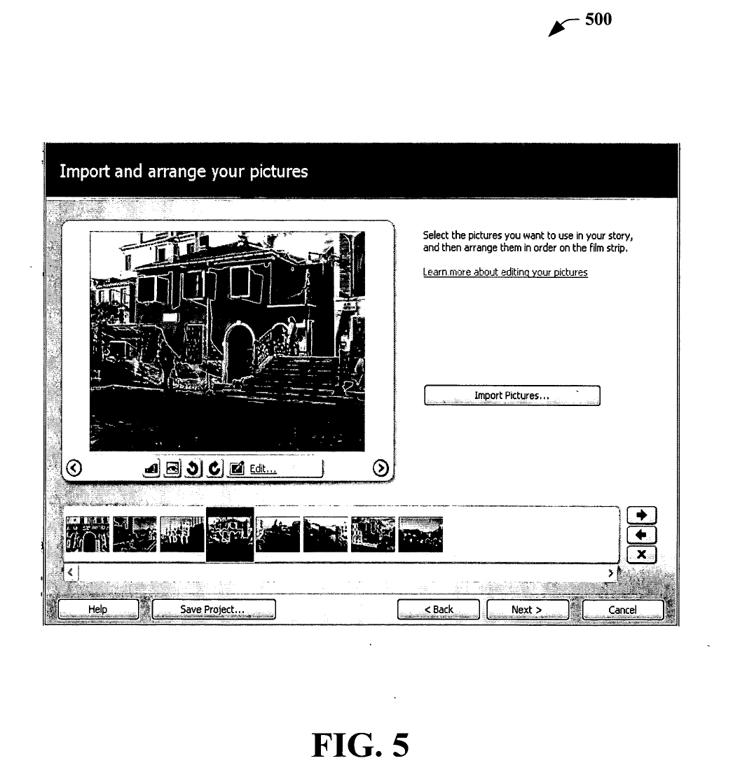

FIG. 5 illustrates a user interface 500 that provides novice functionality as well as advanced functionality related to importing and editing pictures associated to an image-based video. It is to be appreciated the following is an example relating to an image-based video authoring application, wherein the subject invention is not so limited and that any suitable application and/or instruction(s) can be utilized. The user interface 500 can be employed by the subject invention to provide the execution of instruction(s) allowing versatility in operations for a range of skilled users. The instruction(s) can relate to an application, wherein the application consists of tasks, operations that can be organized into pages and/or steps to provide guidance in such application. These instruction(s) can be employed by utilizing the user interface 500.

The user interface 500 is an example of a page within an image-based video authoring application. By utilizing the page, the user can insert and arrange pictures for the image-based video. Such operation can be seen as a core operation and/or common task. The common task can include basic editing operations such as, for example, rotating a picture. Yet, the user interface 500 can provide operations and/or tasks for advanced users by employing an “Edit” link and/or button. This link and/or button can launch another auxiliary user interface to provide advanced (e.g., more complex) editing functionality. It is to be appreciated that the user interface 500 is only an example relating to an image-based video application and such functionality and limitations are not to be construed to the subject invention.

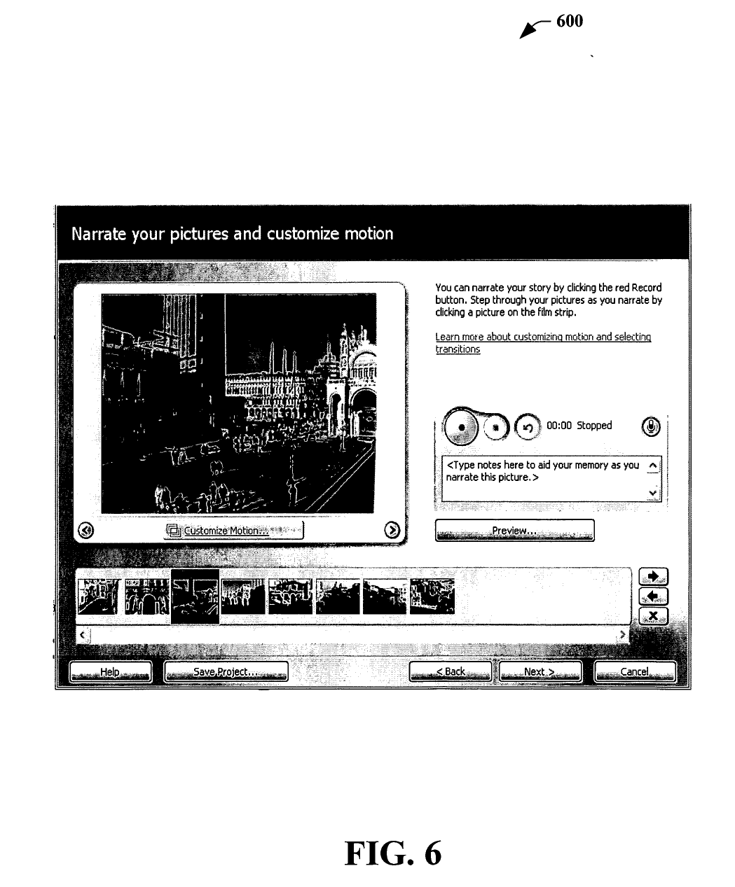

FIG. 6 illustrates a user interface 600 that provides novice functionality as well as advanced functionality related to motion and/or audio associated to image-based video. It is to be appreciated the following is an example relating to an image-based video authoring application, wherein the subject invention is not so limited and that any suitable application and/or instruction(s) can be utilized. Instruction(s) can be included within the image-based video application, wherein the application consists of tasks, operations that can be organized into pages and/or steps to provide guidance in such application. These instruction(s) can be employed by utilizing the user interface 600.

The user interface 600 depicts a page from the image-based video authoring application. The page can contain controls that allow the user to add narration and/or audio to each picture. Yet, the more advanced user can invoke advanced and/or customized settings with a “Customize motion” option. The “Customize motion” option can allow the advanced user to customize the motion effects for each picture. The user interface 600 can be employed such that guidance can be provided relating to common tasks for a novice user, while allowing more difficult and/or complicated options to be accessed by a highly-skilled user. In other words, the simplicity of guiding the user through an application can be maintained by presenting the complex operations and/or tasks via optional auxiliary user interface so that it does not deter or intimidate a novice and/or beginning user.

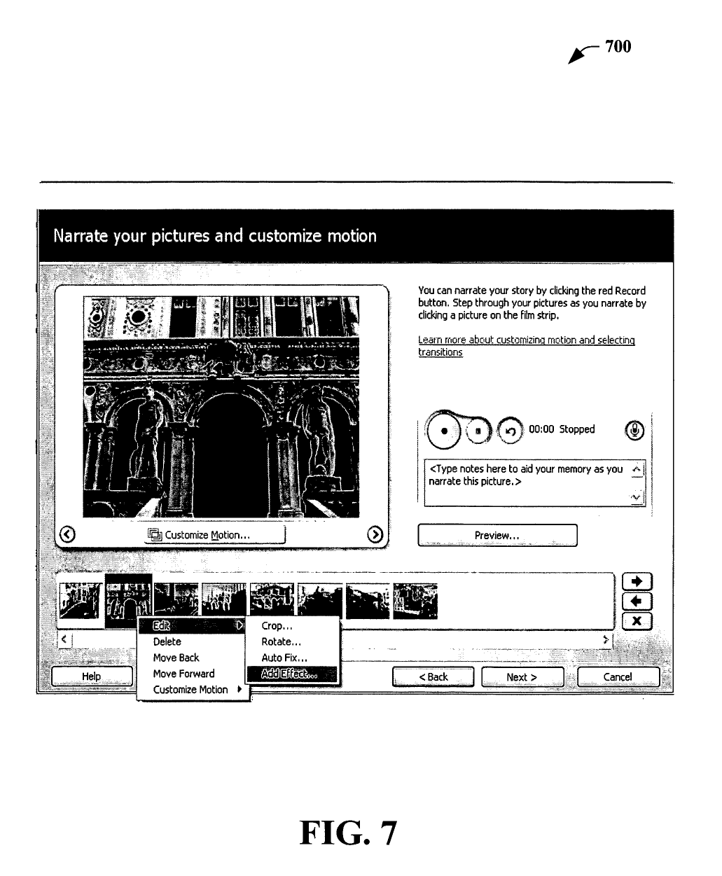

FIG. 7 illustrates a user interface 700 that invokes instruction(s) to allow access via multiple clicks to advanced functionality associated with various stages within image-based video authoring. The user interface 700 can provide access to any operation involved with an application (e.g., a set of instruction(s)) during any step and/or stage. The following is an example relating to an image-based video authoring application, yet the subject invention is not so limited such that any suitable application and/or instruction(s) can be invoked. The user interface 700 can provide access to the operations and/or tasks involved with the page associated thereto including any advanced options associated with the page. Yet, the user interface 700 is not limited to access operations and/or tasks relating to the current step and/or stage. For example, using context menus, other operations not directly associated with the page can be invoked. In the example page from image-based video authoring application, the primary task on the page is to add narration and/or audio to at least one picture. However, using context menus, an advanced user can choose to access photo editing functionality from such page.

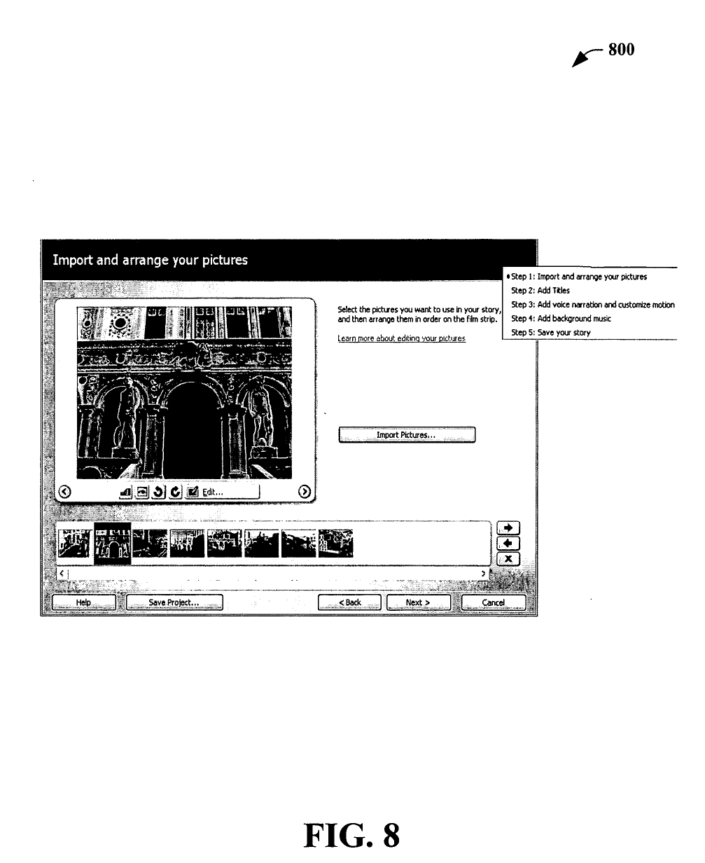

Turning to FIG. 8, a user interface 800 is illustrated that invokes instruction(s) to allow access via text to various stages within image-based video authoring. The user interface 800 provides another example of navigation throughout the various stages and/or steps relating to the guidance of executing instruction(s) within an application. The user interface 800 can provide a “one click access” to any page during any stage and/or step within the execution of instruction(s). For example, the user can click an option on the user interface and pull up a context menu that can allow the user to jump to any page in the guidance. In particular, the user interface 800 can be enhanced by allowing the user to determine the number of pages that are associated to the application and which page the user is currently utilizing. For instance, the execution of instruction(s) and/or the application can include ten stages, wherein each stage consists of tasks and/or operations (e.g., common tasks/operations and/or advanced tasks/operations) and each stage can be represented by a page (e.g., a user interface and/or a user interface that allows access to each page). The subject invention can invoke a user interface that allows a user to complete tasks within each stage accordingly. Thus, to allow versatility and flexibility for advanced users, the subject invention allows direct access to any stage within the application.

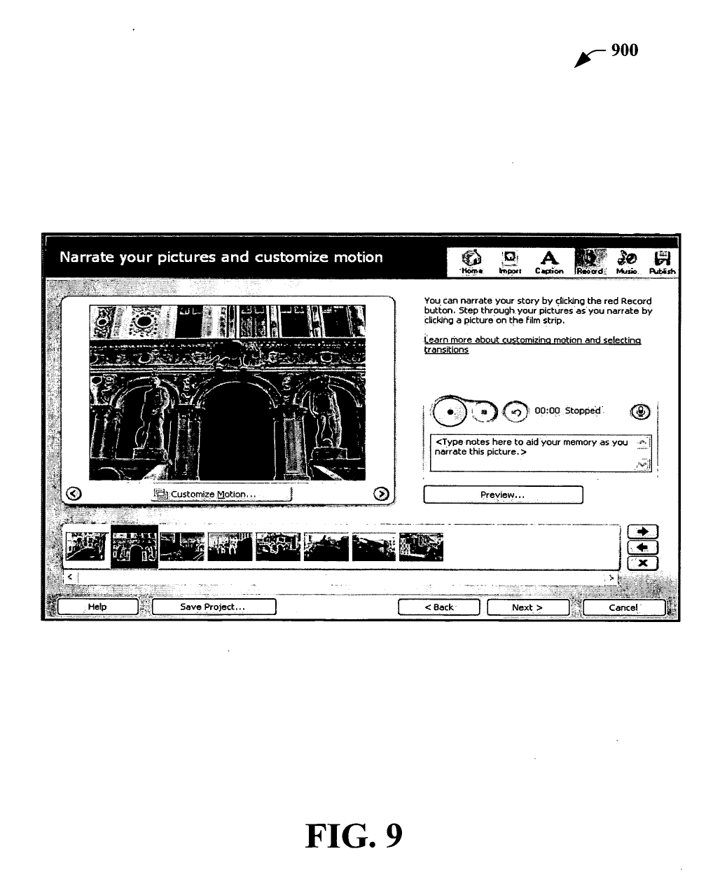

Briefly turning to FIG. 9, a user interface 900 is illustrated that invokes instruction(s) to allow access via a map of image(s) to various stages within image-based video authoring. The user interface 900 provides another example of navigation throughout the various stages and/or steps relating to the guidance of executing instruction(s) within an application. The user interface 900 can provide a “one click access” to any page during any stage and/or step within the execution of instruction(s). The user interface 900 can provide a visual map of the page and indicate wherein the guidance the user is located. It is to be appreciated that the visual map can be a thumbnail that represents each stage, page, and/or step within the application guidance sequence.

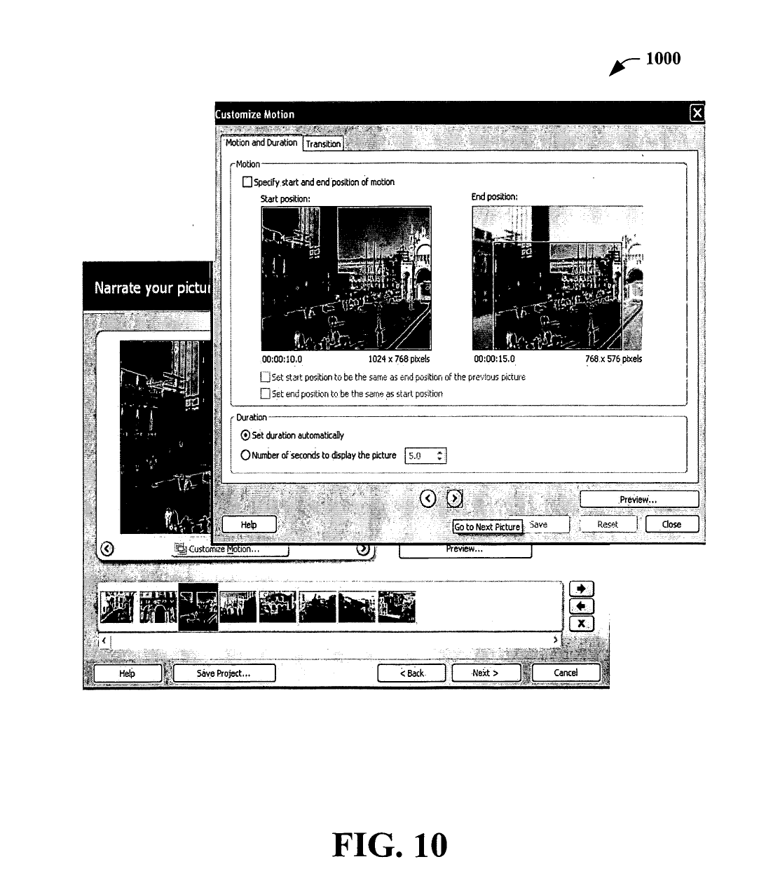

FIG. 10 illustrates a user interface 1000 that invokes instruction(s) associated to a stage within image-based video authoring. The user interface 1000 can allow a user to traverse through any picture associated to the application. It is to be appreciated the following is an example relating to an image-based video authoring application, wherein the subject invention is not so limited and that any suitable application and corresponding instruction(s) can be utilized. The user can open an advanced user interface page and perform a specific task and/or operation for at least one picture. The next picture and previous picture controls provide access to all pictures associated with the application. To give the advanced user notice of where, within the multitude of pictures, the picture currently selected in the advanced auxiliary page is, the picture selection is automatically reflected in the main page. Put side by side, the main page and advanced auxiliary page allow the user to perform advanced tasks, such as manually assigning motion over a picture, not only based on the currently selected picture but in relationship with other pictures.

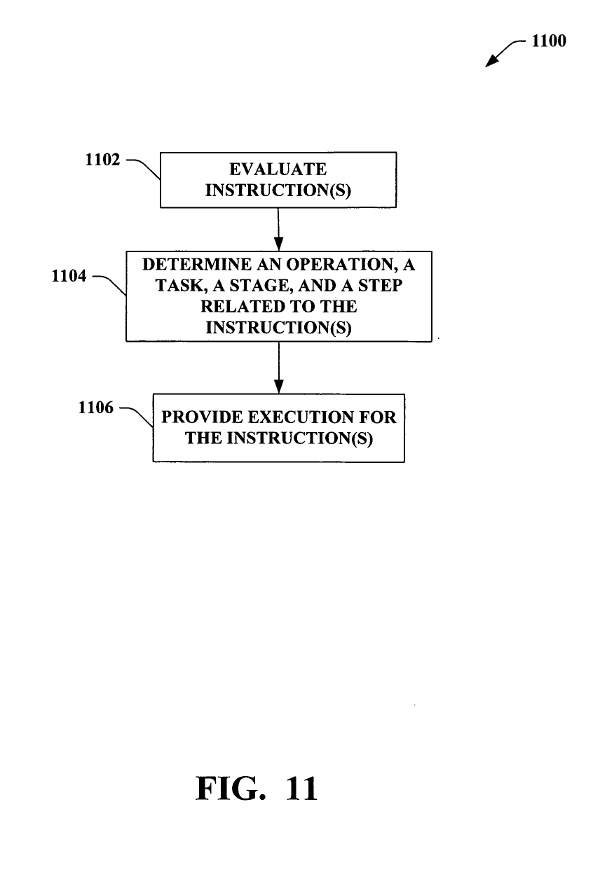

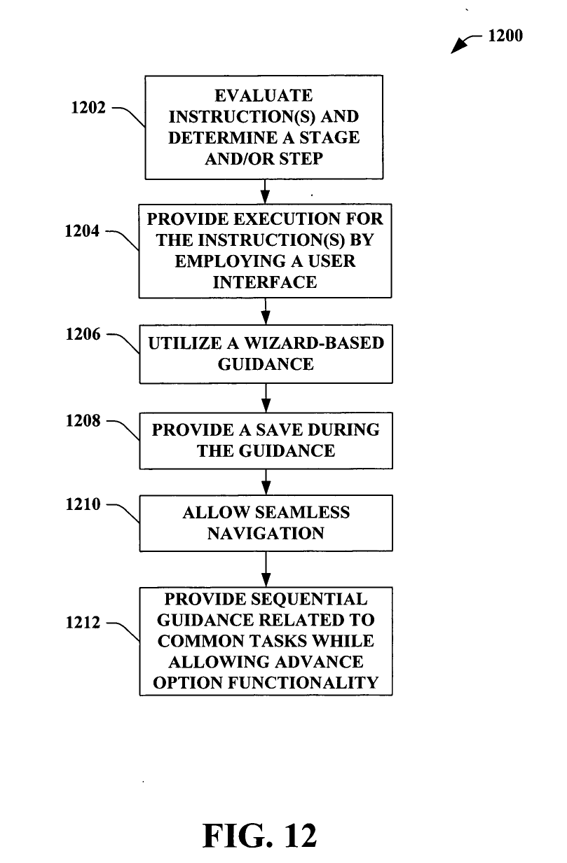

FIGS. 11-12 illustrate methodologies in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 11 illustrates a methodology 1100 for invoking instruction(s) to provide a range of functionality. At reference numeral 1102, at least one instruction(s) can be evaluated. The instruction(s) can relate to, for example, an application, a software, a hardware, a computer, etc. that can be executed to provide a particular output. For instance, instruction(s) can relate to an image-based video authoring application. Although the instruction(s) can be associated to the image-based video authoring application, such example is not to be limiting on the subject invention. In another example, the instruction(s) can relate to a jewel case creator application.

At reference numeral 1104, at least one of an operation, a task, a stage, and a step related to the instruction(s) can be determined. The instruction(s) can be parsed such that these tasks and/or operations can be collectively packaged into a sequential guidance having at least one step and/or stage, where the total steps and/or stages can produce a particular output associated with the instruction(s). For instance, the image-based video authoring application can have various instruction(s) that can be grouped into a specific number of stages. At reference numeral 1106, the instruction(s) can be executed. In particular, the tasks and/or operations packaged into the stage and/or step can be either automatically executed, manually executed by a user, and/or a combination thereof. In one example, the instruction(s) can be automatically executed for common tasks and/or operations, while manual execution can be reserved for complicated and/or advanced tasks and/or operations.

FIG. 12 illustrates a methodology 1200 to facilitate invoking a multitude of instruction(s) that provide a range of functionality simultaneously for a novice user and an advanced user. At reference numeral 1202, instruction(s) can be evaluated to determine at least one of a step and/or stage associated to a package of operations and/or tasks. At reference numeral 1204, the execution for the instruction(s) can be implemented by employing a user interface. At reference numeral 1206, a wizard-based guidance can be employed to execute the instruction(s). For instance, the instruction(s) can be executed by utilizing a wizard-based user interface. The wizard-based user interface allows the instruction(s) to be automatically executed for common tasks and/or operations, while manually executing is reserved for complicated and/or advanced tasks and/or operations. In particular, the wizard-based guidance can provide a sequential grouping of steps and/or stages that have various operations and/or tasks associated therewith.

At reference numeral 1208, a save can be provided during the wizard-based guidance. It is to be appreciated and understood that the save can be invoked at any stage, step, task, operation, etc. related to the instruction(s) and/or the application. For instance, the save can be made regardless of the progress in relation to the particular output of the instruction(s). At reference numeral 1210, seamless navigation can be provided. The seamless navigation provides the access to any operation and/or task regardless of the stage and/or step that the user interface is currently performing. In one example, a context menu allows launching previous auxiliary user interface windows for advanced controls by utilizing a “one click access.” In yet another example, the user interface can provide seamless navigation by employing a visual map that represents various pages, steps, and/or stages related to the application and/or instruction(s). At reference numeral 1212, the sequential guidance related to common tasks and/or operations associated with the stage is provided while allowing advance option functionality to be accessible through auxiliary user interface windows. Additionally, the instruction(s) can be automatically executed for common tasks and/or operations, while manual execution can be reserved for complicated and/or advanced tasks and/or operations. Such implementation provides versatility in the wizard-based user interface that is suitable for a wide range of users' skills from a novice to an expert.

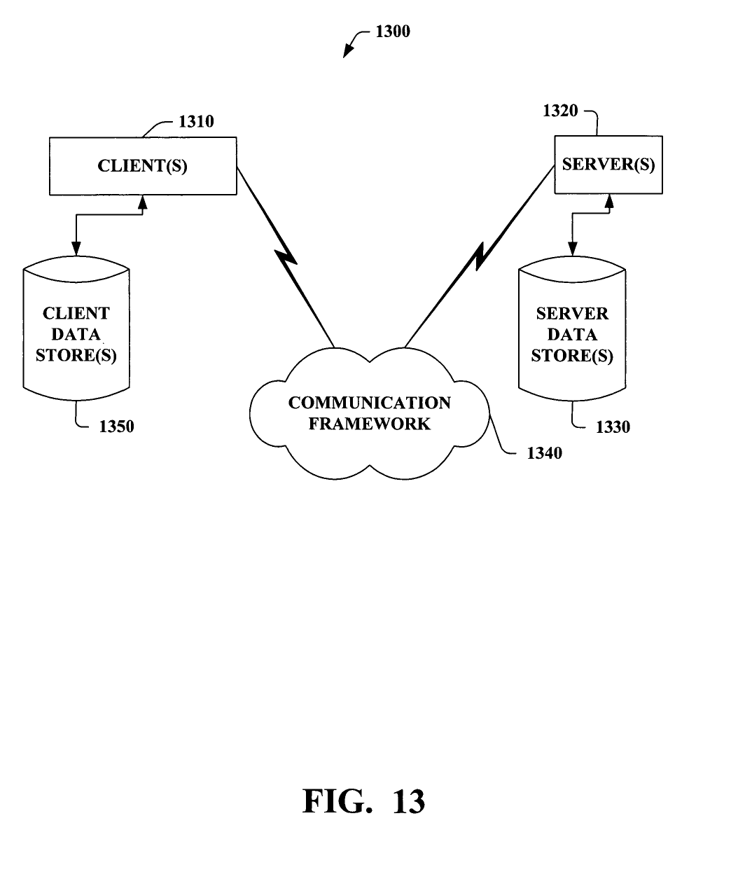

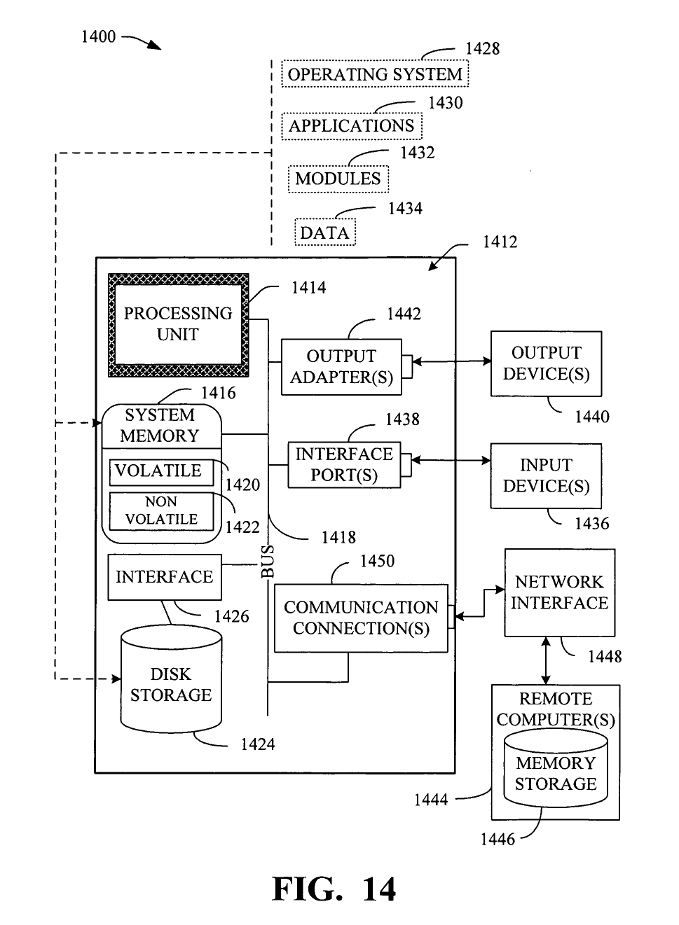

In order to provide additional context for implementing various aspects of the subject invention, FIGS. 13-14 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 13 is a schematic block diagram of a sample-computing environment 1300 with which the subject invention can interact. The system 1300 includes one or more client(s) 1310. The client(s) 1310 can be hardware and/or software (e.g., threads, processes, computing devices). The system 1300 also includes one or more server(s) 1320. The server(s) 1320 can be hardware and/or software (e.g., threads, processes, computing devices). The servers 1320 can house threads to perform transformations by employing the subject invention, for example.

One possible communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 1310. Similarly, the server(s) 1320 are operably connected to one or more server data store(s) 1330 that can be employed to store information local to the servers 1340.

With reference to FIG. 14, an exemplary environment 1400 for implementing various aspects of the invention includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1412 also includes removable/non-removable, volatile/non-volatile computer storage media. FIG. 14 illustrates, for example a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in the suitable operating environment 1400. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the subject invention can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates invoking execution of computer-implemented instructions, comprising:
an interface that receives an entity input respective to a user interface; and
an instruction manager component that executes an instruction as a function of the entity input, wherein a configuration is automatically determined and an advanced configuration is manually determined by the entity input.

2. The system of claim 1, the entity is at least one of a user, a computer, an application, and a pre-defined setting.

3. The system of claim 1, the instruction is associated to an application with at least one operation packaged as at least one stage such that an output is produced from a culmination of the at least one stage.

4. The system of claim 3, the instruction manager component sequentially invokes at least one of the following: 1) the stage in the form of a page, wherein each page provides the entity with guidance to execute operations within the stage; and 2) a wizard-based user interface to provide the sequential guidance through at least one stage associated to an application.

5. The system of claim 1, further comprising a save component that saves a progress regardless of a location within the execution of the instruction, wherein the save is invoked by at least one of an automatic technique, manually by the entity, and a combination thereof.

6. The system of claim 3, further comprising a traverse component that provides the invoking of an operation for the entire content associated to the output.

7. The system of claim 3, further comprising an access component that allows the entity access to the operations in any stage regardless of location within the sequence of stages.

8. The system of claim 7, the access component utilizes a context menu that invokes at least one operation associated with a stage.

9. The system of claim 7, the access component utilizes a context menu that invokes at least one operation associated with a stage that is different from the current stage.

10. The system of claim 7, the access component utilizes a visual map that provides at least one of the following: (1) shows all the stages; (2) indicates the current stage; and (3) provides controls for random access to any stage.

11. The system of claim 4, the page contains at least one common operation associated with that stage and provides an optional access to an auxiliary window that contains controls for accessing and utilizing an advanced functionality respective to such stage.

12. The system of claim 3, the instruction manager component implements a default setting associated to the application respective to at least one of the operation, the stage, the output, an entity profile, and an application usage history, wherein the entity can update the default setting manually.

13. A computer readable medium having stored thereon the components of the system of claim 1.

14. A computer-implemented method that facilitates invoking execution of computer-implemented instructions, comprising:
evaluating an instruction respective to an application;
parsing the application into at least one operation; and
executing the instruction based as a function of an operation complexity.

15. The method of claim 14, further comprising packaging the at least one operation into a stage.

16. The method of claim 15, further comprising automatically determining a configuration and allowing a manual adjustment of the configuration, the configuration is associated to an operation within the stage.

17. The method of claim 15, further comprising at least one of the following:
utilizing a wizard-based guidance;
providing a save during the execution of the instruction;
implementing a default setting to at least one of the operation and the stage; and
allowing a seamless navigation to access any operation.

18. The method of claim 17, further comprising utilizing an inference technique to implement the default setting of at least one of the operation and the stage.

19. A data packet that communicates between an instruction manager component and an interface, the data packet facilitates the method of claim 14.

20. A computer-implemented system that facilitates invoking execution of computer-implemented instructions, comprising:
means for receiving an entity input respective to a user interface; and
means for executing an instruction as a function of the entity input, wherein a configuration is automatically determined and an advanced configuration is manually determined by the entity input.
